(19) United States
(12) Patent Application Publication
(10) Pub. No.: US 2002/0122408 A1
(43) Pub. Date: Sep. 5, 2002

(54) Satellite communications with satellite routing according to channels assignment signals

(76) Inventor: Dennis R Mullins, London (GB)

Correspondence Address: Nixon & Vanderhye, 8th Floor, 1100 North Glebe Road, Arlington, VA, 22201-4714, US

(21) Appl. No.: 10/069,482

(22) PCT Filed: Feb. 23, 2001
(86) PCT No.: PCT/GB01/00805

(30) Foreign Application Priority Data
Feb. 29, 2000 (GB) 0004856.1

(51) Int. Cl. H04J 3/02

(52) U.S. Cl. 370/347; 370/537

(57) ABSTRACT

A satellite system comprising at least one satellite (4) at least one Earth station (6), and a plurality of user terminals (2), the satellite (4) being arranged to provide a link between each user terminal (2) and the Earth station (6), via communications channels, each channel comprising one or more timeslots in a repeating time frame on one or more frequencies, carried by a feeder link beam between said satellite (4) and the or each said Earth station (6), and one of a plurality of user terminal link beams (B1-BN) between the satellite (4) and the user terminals (2), the satellite comprising a multiplexer (211) for multiplexing the channels from multiple said terminal link beams onto each said feeder link beam, and a demultiplexer (111) for demultiplexing the channels from onto each said feeder link beam onto multiple said terminal link beams, and further comprising at least one router (112, 212) for assigning channels to and from particular said terminal link beams in response to control signals from said Earth station (6), characterized in that the Earth station (6) is arranged to send, during a first said frame period, channel assignment signals relating to channel assignments in a following said frame period, and in that the satellite (4) is arranged to control the router (112, 212) in accordance with said channel assignment signals in said following frame period.

This invention relates to satellite communications and particularly to multipoint satellite communications, such as mobile communications.

Satellite mobile communications systems are well known. In recent years, a number of certain systems have been proposed, including the recently launched Iridium system, and the proposed GlobalStar and ICO systems, which are intended for communications with small mobile terminals such as handsets.

As use of information technology increases, there is an increasing demand for bandwidth which is, however, a scarce resource for satellite systems since they must avoid conflict with any terrestrial usages in many different countries.

The present invention is intended to provide a bandwidth-efficient satellite communications system, particularly for relatively low porter mobile terminals.

In one aspect, the invention provides a method of TDMA satellite communications with a user terminal, in which the satellite separately routes individual TDMA bursts of a given frequency channel and varies said routing from frame to frame.

Other aspects and preferred embodiments of the invention, together with corresponding advantages, will be apparent from the following description, drawings and claims.

Embodiments of the invention will now be illustrated, by way of example only, with reference to the accompanying drawings in which:

### BRIEF DESCRIPTION OF THE DRAWINGS

Embodiments of the invention will now be described, by way of example only, with reference to the accompanying drawings, in which:

FIG. 1 is a block diagram showing schematically the elements of a communications system embodying the present invention:

FIG. 2 is a block diagram showing schematically the elements of an Earth station node forming part of the embodiment of FIG. 1;

FIG. 3 illustrates schematically the disposition of satellites forming part of FIG. 1 in orbits around the Earth;

FIG. 4 illustrates schematically the beams produced by a satellite in the embodiment of FIG. 1;

FIG. 5 is a cross section through a beam, showing gain against angular displacement from the antenna boresight axis;

FIG. 6a is a diagram showing illustrative a feeder link spectrum in a first embodiment; and

FIG. 6b is a diagram showing illustrative a user link spectrum in that embodiment over time;

FIG. 7 is a block diagram illustrating schematically the structure of the payload of a satellite transponder;

FIG. 8 is a block diagram showing the structure of time frequency demultiplexing apparatus within the payload of FIG. 7;

FIG. 9 shows schematically the content of a database forming part of the satellite payload of FIG. 7;

FIG. 10 is a diagram illustrating the contents of a database forming part of the Earth station of FIG. 2;

FIG. 11 is a flow diagram showing the operation of the satellite payload of FIG. 7;

FIG. 12a is a flow diagram showing the process of setting up a signalling connection carried out by the user terminal of the first embodiment; and

FIG. 12b is a flow diagram showing the corresponding process performed by the Earth station;

FIG. 13 is a flow diagram showing the process performed by the Earth station in allocating TDMA channels; and

FIG. 14 is a flow diagram showing the process performed by the Earth station in the first embodiment in re-allocating TDMA channels.

First Embodiment

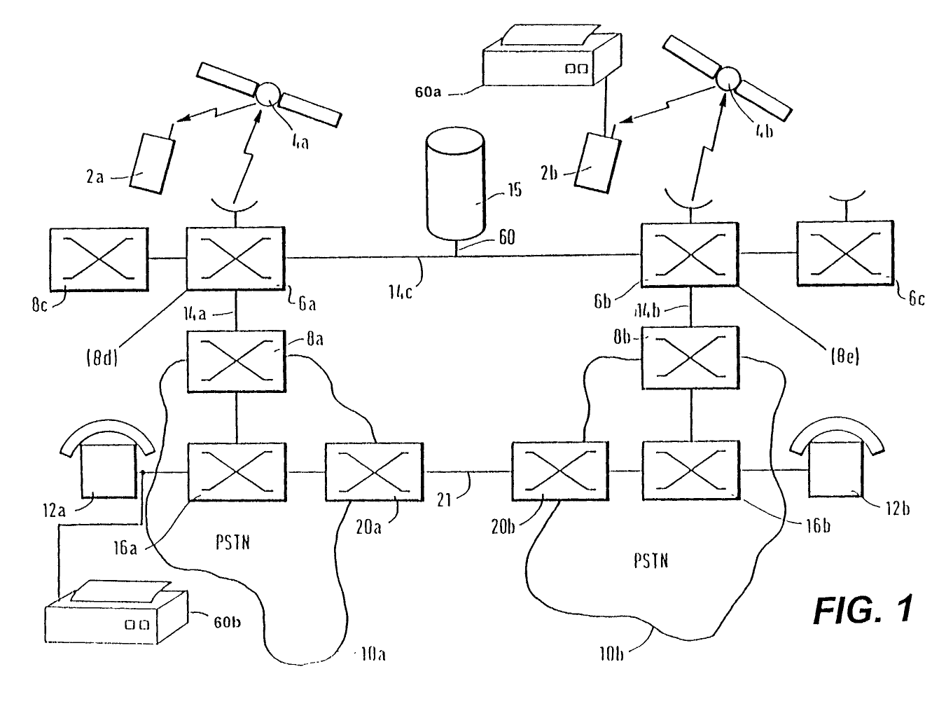

Referring to FIG. 1, a satellite communications network according to this embodiment comprises mobile user terminal equipment 2a, 2b (e.g. handsets 2a and 2b); orbiting relay satellites 4a, 4b; satellite Earth station nodes 6a, 6b, satellite system gateway stations 8a, 8b; terrestrial (e.g. public switched) telecommunications networks 10a, 10b; and fixed telecommunications terminal equipment 12a, 12b.

Interconnecting the satellite system gateways 8a, 8b with the Earth station nodes 6a, 6b, and interconnecting the nodes 6a,6b with each other, is a dedicated ground-based network comprising channels 14a, 14b, 14c. The satellites 4, Earth station nodes 6 and lines 14 make up the infrastructure of the satellite communications network, for communication with the mobile terminals 2, and accessible through the gateway stations 8.

A terminal location database station 15 (equivalent to a GSM HLR) is connected, via a signalling link 60 (e.g. within the channels 14 of the dedicated network), to the gateway station and Earth stations 6.

The PSTNs 10a, 10b comprise, typically, local exchanges 16a, 16b to which the fixed terminal equipment 12a, 12b is connected via local loops 18a, 18b; and international switching centres 20a, 20b connectable one to another via transnational links 21 (for example, satellite links or subsea optical fibre cable links). The PSTNs 10a, 10b and fixed terminal equipment 12a, 12b (e.g. telephone instruments) are well known and almost universally available today.

For voice communications, each mobile terminal apparatus is in communication with a satellite 4 via a full duplex channel (in this embodiment) comprising a downlink channel and an uplink channel, for example (in each case) a TDMA time slot on a particular frequency allocated on initiation of a call, as disclosed in UK patent applications GB 2288913 and GB 2293725. The satellites 4 in this embodiment are non geostationary, and thus, periodically, there is handover of each user from one satellite 4 to another.

Terminal 2

The user terminals (UT's) 2a, 2b may be similar to those presently available for use with the GSM system, comprising a digital low rate coder/decoder, together with conventional microphone, loudspeaker, battery and keypad components, and a radio frequency (RF) interface and antenna suitable for satellite communications.

Each UT 2 comprises an omnidirectional antenna. i.e. an antenna having generally satisfactory communications performance at all directions above a certain minimum elevation above the horizon (such as ten degrees) so as not to require pointing or steering to a satellite.

Small satellite communications terminals are currently available (with omnidirectional antennas) for the Iridium system from Motorola Inc, and (with steered antennas) for the Inmarsat-M and mini-M systems, for example.

Terminals may be connected, as shown, to data terminal equipment 160a, 160b such as a facsimile machine or a personal computer.

Earth Station Node 6

The Earth station nodes 6 are arranged for communication with the satellites.

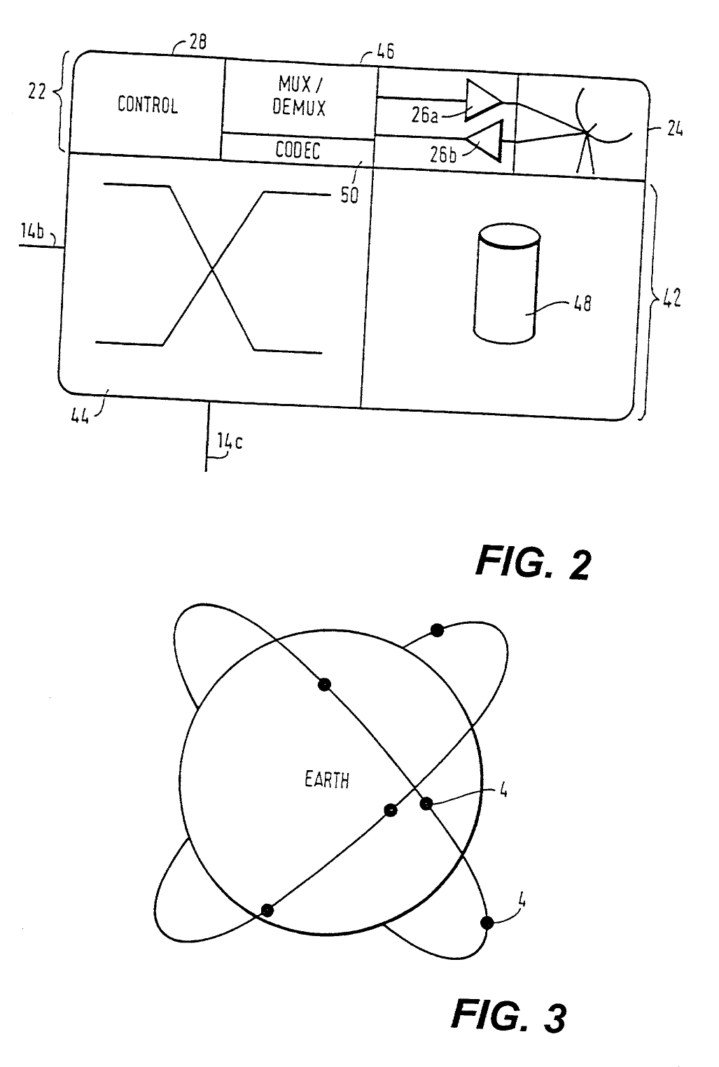

Each Earth station node 6 comprises, as shown in FIG. 2, a conventional satellite Earth station 22 (functioning somewhat equivalently to the Base Station of a cellular system) consisting of at least one satellite tracking antenna 24 arranged to track at least one moving satellite 4, RF power amplifiers 26a for supplying a signal to the antenna 24, and 26b for receiving a signal from the antenna 24; and a control unit 28 for storing the satellite ephemera data, controlling the steering of the antenna 24, and effecting any control of the satellite 4 that may be required (by signalling via the antenna 24 to the satellite 4).

The Earth station node 6 further comprises a mobile satellite switching centre 42 comprising a network switch 44 connected to the trunk links 14 forming part of the dedicated network. It may be, for example, a commercially available mobile switching centre (MSC) of the type used in digital mobile cellular radio systems such as GSM systems.

A multiplexer 46 is arranged to receive switched calls from the switch 44 and multiplex them into a composite signal for supply to the amplifier 26 via a low bit-rate voice codec 50. Finally, the Earth station node 6 comprises a local store 48 storing details of each mobile terminal equipment 2a within the area served by the satellite 4 with which the node 6 is in communication. The local store 48 acts to fulfil the functions of a visited location register (VLR) of a GSM system, and may be based on commercially available GSM products.

Alternatively, satellite control may be provided from a separate control station.

Other Network Elements

The gateway stations 8a, 8b comprise, in this embodiment, commercially available mobile switch centres (MSCs) of the type used in digital mobile cellular radio systems such as GSM systems. They could alternatively comprise a part of an international or other exchange forming one of the PSTNs 10a, 10b operating under software control to interconnect the networks 10 with the satellite system trunk lines 14.

The gateway stations 8 comprise a switch arranged to interconnect incoming PSTN lines from the PSTN 10 with dedicated service lines 14 connected to one or more Earth station nodes 6.

The database station 15 comprises a digital data store which contains, for every subscriber terminal apparatus 2, a record showing the identity (e.g. the International Mobile Subscriber Identity or IMSI); the service provider station 8 with which the apparatus is registered (to enable billing and other data to be collected at a single point) and the currently active Earth station node 6 with which the apparatus 2 is in communication via the satellite 4.

Thus, in this embodiment the database station 15 acts to fulfil the functions of a home location register (HLR) of a GSM system, and may be based on commercially available GSM products.

Periodically, the Earth station nodes measure the delay and Doppler shift of communications from the terminals 2 and calculate the rough terrestrial position of the mobile terminal apparatus 2 using the differential arrival times and/or Doppler shifts in the received signal. The position is then stored in the database 48.

The Earth stations 6 are positioned dispersed about the Earth such that for any orbital position, at least one Earth station 6 is in view of a satellite 4.

Referring to FIG. 3, a global coverage constellation of satellites is provided, consisting of a pair of orbital planes each inclined at 45 degrees to the equatorial plane, spaced apart by 90 degrees around the equatorial plane each comprising ten pairs of satellites 4a, 4b, (i.e. a total of 20 operational satellites) the pairs being evenly spaced in orbit, with a phase interval of zero degrees between the planes (i.e. a 10/2/0 constellation in Walker notation) at an altitude of about 10,000 km.

Thus, neglecting blockages, a UT at any position on Earth can always have a communications path to at least one satellite 4 in orbit (“global coverage”).

Satellites 4

The satellites 4 comprise a bus module and a payload module. The bus module comprises the elements of the satellite which are common to all satellite applications.

Specifically, the bus module comprises a propulsion system comprising thrusters for maintaining the satellite in its assigned orbital position; a power subsystem comprising, for example, a pair of solar power-wings pointed at the sun and a storage battery charged from the solar panel and discharged when the satellite is not in view of the sun; and a thermal control subsystem to dissipate heat.

Also provided are an attitude control subsystem arranged, in this case, to direct the body of the satellite towards the Earth and the solar cells towards the sun as described in our earlier application No. GB 2320232; and a telemetry and command system by which the satellite transmits data concerning its operating conditions and receives commands from a satellite control centre causing it to, for example, adjust its position in orbit.

The bus may be, for example, the HS601 or HS601 high power satellites, or the HS702 satellite, all available from Hughes Space and Communications Company, in California, US.

Satellite Payload

Each satellite payload generates a plurality of spatially separated user link radio frequency beams, B1-BN in a manner described in more detail below.

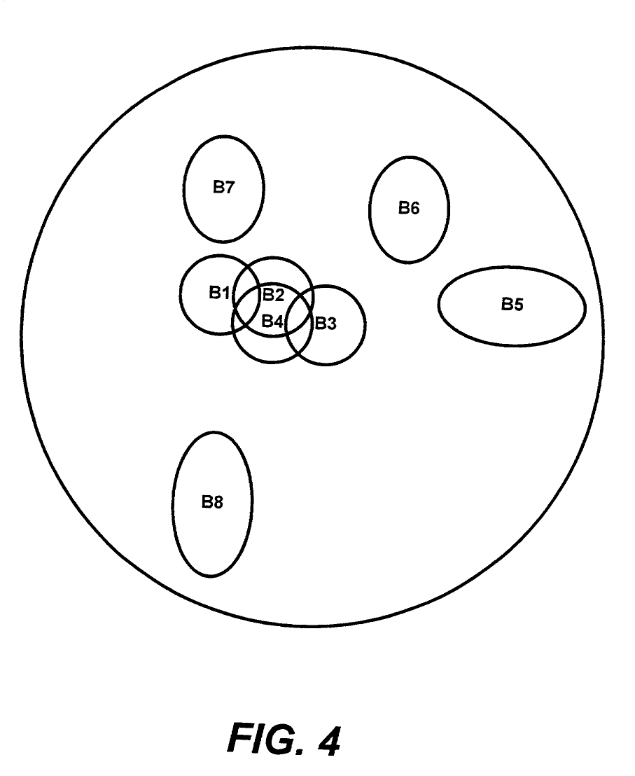

Each satellite also has an array of radiation reception directions which intercept the surface of the Earth; the reception directions roughly coincide with the beams. The directions of the beams are at defined stereo angles with the antenna centre axis or “boresight”, which (in this embodiment) is directed vertically towards the centre of the Earth. Each beam is directed towards a respective user terminal. Thus, as shown in FIG. 4, the beams are unevenly distributed over the satellite footprint—i.e. the portion of the Earth visible from the satellite (or which has visibility of the satellite above some minimum elevation angle such as 10°).

Any beam which is not centred on the boresight axis will have a non-circular profile, derived as the intersection of the conical beam with the spherical surface of the Earth. The sizes and shapes of the beams therefore vary with their positions (i.e. the position of the beam centre, referred to here as the ‘beam aim point’) on Earth.

The satellite also generates global uplink and downlink beams (e.g. a beam covering the whole satellite footprint area of the Earth) for carrying signalling traffic for setting up and pulling down calls, and requesting changes to allocated channel capacity. These may be generated by the same array antennas or by additional antennas (not shown).

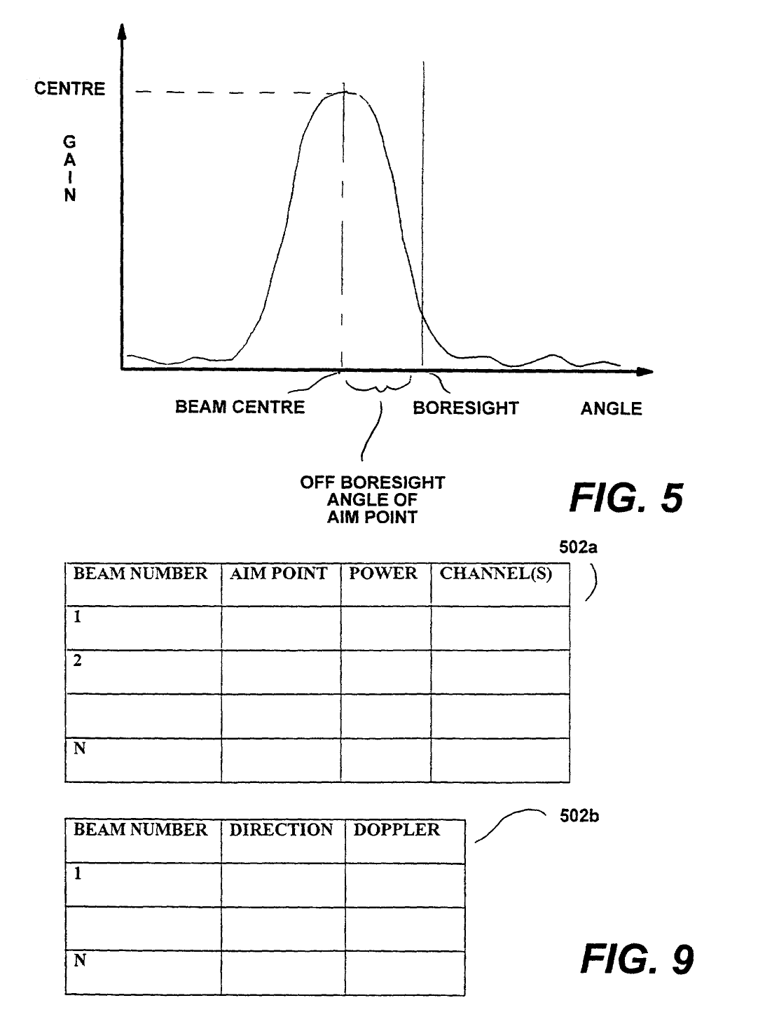

FIG. 5 illustrates the beam profile in section. The gain falls away from a maximum value at the beam centre. Beyond some point (e.g. 1 dB or 3 dB down) the beam may be unsuitable for use; this therefore defines the “edge” of the beam. However, the beam continues to have an amplitude, and thus to be capable of interfering with other co-channel users, beyond this “edge”.

The satellite payload comprises at least one steerable high gain spot beam antenna 3 providing a feeder link for communicating with one or more fixed Earth stations 6 connected to telecommunications networks, a receive array antenna 1 for receiving the plurality of reception directions R1-RN; and a transmit array antenna 200 for generating the plurality of beams B1-BN. The antennas 1-3 are provided on the side of the satellite which is maintained facing the Earth.

The transmit and receive antennas each comprise two dimensional array antennas with, for example, a few hundred elements each.

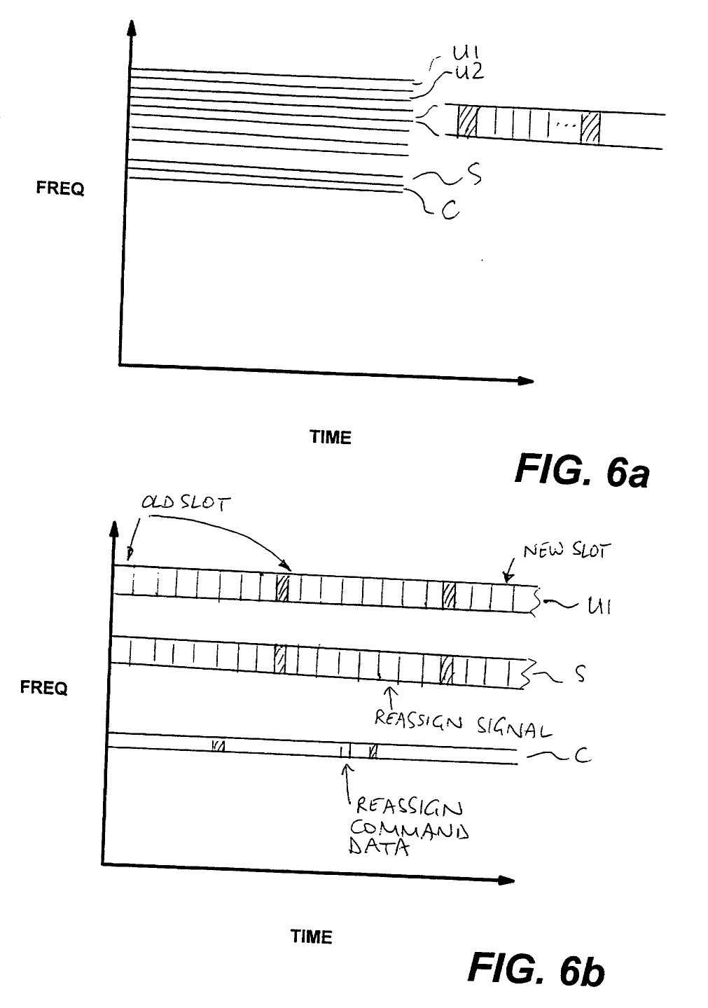

A brief explanation of the access methods employed will now be given, with reference to FIG. 6. The feeder link antenna 3 operates at a transmit frequency of 7 GHz and a receive frequency of 5 GHz. The receive array antenna operates at a frequency of 2 GHz and the transmit array antenna at a frequency of 2.2 GHz.

The bandwidth available for each channel is 4 KHz, which is adequate for speech. Time Division Multiple Access (TDMA) is employed, with 40 mS frames. In the to-mobile direction, there are 36 timeslots in each repeating frame, on frequency subcarriers each of 150 KHz bandwidth. In the from-mobile direction, there are 6 timeslots in each frame, on frequency subcarriers each of 25 KHz bandwidth.

As is shown in FIG. 6a, the feeder length spectrum consists of a set of frequency channels U1, U2 which, on the forward (to-mobile) link, are each of 150 KHz bandwidth. No significant frequency guardbands between frequency channels are provided, and no Doppler compensation is applied the channels separately; thus, the spacing between nominal channel centre frequencies is 150 KHz.

Each of the channels carries (in the forward direction) 36 timeslots.

The channels and timeslots are closely packed, to conserve the feeder link spectrum and hence reduce interference with other systems.

A signalling channel S is provided within the feeder link spectrum. The signalling channel carries timeslots permitting random access on initiation of a call in the from-mobile direction, and paging time slots in the to-mobile direction for paging a mobile terminal. It also carries timeslots for instructing mobile terminals to change channel (i.e. change frequency or timeslot).

Finally, a control channel C is provided within the feeder link beam, which carries control signals for reconfiguring the satellite payload.

In the feeder downlink spectrum, user channels are similarly multiplexed together into a composite beam and the signalling channel carries signals from mobile terminals (for example indicating signal strength or other information). No control channel is provided.

Referring to FIG. 6b, the timing relationship between the control channel the signalling channel and the traffic channels is shown (in the tomobile direction). On each channel, a repeating frame structure of length 40 mS is employed. Successive frames are separated by frame header sequences for, amongst other things, synchronisation purposes.

On the control channel, payload configuration information is also sent in time frames. The time frames are not aligned with those on the traffic and signalling channels; each time frame on the control channel carries configuration information for the next traffic channel time frame to begin after the end of that signalling channel time frame.

Conveniently, the frequencies allocated to different satellites are such that no two satellites whose footprints overlap (i.e. who can be seen simultaneously from any point on the ground) share any common frequencies. This is conveniently achieved by partitioning the available frequencies between the two planes of satellites (or, in general. N planes) and then, within each plane, re-using frequencies only on every alternate satellite (or, where levels of coverage higher than double coverage are provided by the constellation, on every Nth satellite).

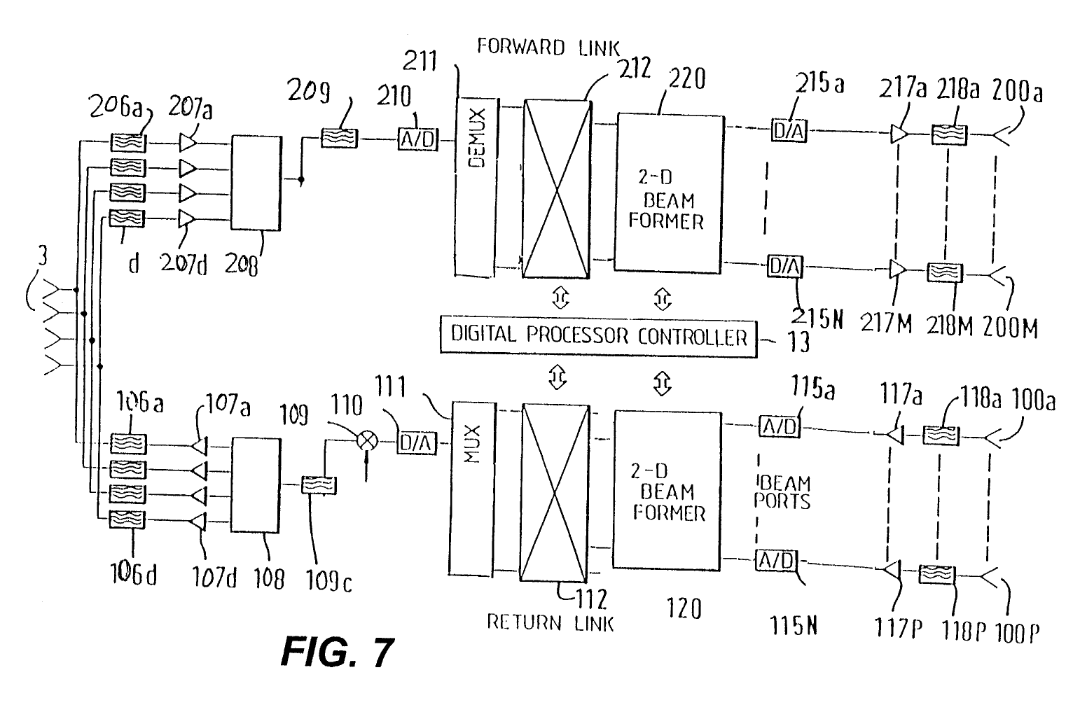

Referring to FIG. 7, the electrical arrangement provided within the satellite payload comprises a forward link, for communicating from an Earth station to a terminal, and a return link, for communicating from the terminal to the Earth station.

The forward link begins at the feeder link antenna 3, the feeder uplink signals from which are bandpass filtered by respective filters 206a-206d and amplified by respective low noise amplifiers 207a-207d. The amplified signals are combined and down-converted to an intermediate frequency (IF) by a combiner/IF downconverter circuit 208. This IF signal is digitised by an analogue to digital converter (ADC) 210.

The control channel of the feed link signal is separated by a filter (not shown for clarity in FIG. 7), and the information it carries is demodulated and feed to the digital processor controller 13.

The digitised IF signals are each then frequency-demultiplexed and down converted into separate 150 KHz bandwidth baseband channels by a demultiplexer 211.

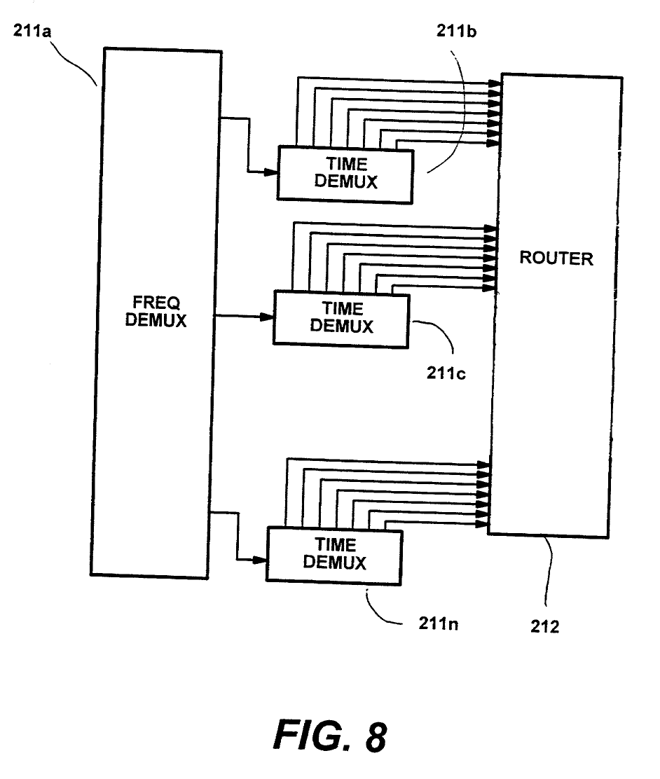

Referring to FIG. 8, the demultiplexer 211 comprises a frequency demultiplexer 211a, and, fed from the outputs of the frequency demultiplexer, a plurality of time demultiplexers 211b, 211c, . . . 211n. Each of the traffic channels separated out by the frequency demultiplexer 211a is fed to a respective time demultiplexer 211b, which routes each of the 36 timeslots in round-robin fashion to a corresponding output port so as to produce, at each output port I a signal burst on the Ith timeslot of each frame (where I ranges from 1-36).

The separated frequency/time channels output from the output ports of all of the time demultiplexers 211b-211n are fed to input ports of the routing network 212. The routing network 212 has one output port for each of the n frequency channels and is arranged to route each of the input ports to one of the output ports under the control of data from the digital processor controller 13. Several different input ports (up to the number of timeslots; in this case 36) may be connected to each output port.

Each of the router output ports is connected to-one of the input ports of a digital beamformer 220, which generates a plurality of energising signals for energising respective radiating elements 200a-200M of the transmit array antenna 200.

The digital beamformer network comprises a Fast Fourier Transform processor which accepts, from the digital control circuit 13, a set of control parameters for each of the frequency and time channels. The control parameters comprise:

The amplitude for the user channel;

The subcarrier frequency;

The Doppler shift offset; and

The angular direction of the beam.

The beamformer is arranged to synthesise beams each in the specified angular direction with respect to the antenna boresight, at the specified frequency, with the desired amplitude, by multiplying the signal by the subcarrier frequency (including Doppler offset).

The energising signals are each converted to an analogue signal by a respective digital to analogue converter (DAC) 215a-215N, the outputs of which are up-converted to a beam frequency lying within a 30 MHz range in the 2.2 GHz band by an array of IF/S band converters, amplified by a bank of M RF power amplifiers 217a-217M, and bandpass filtered by a bank of filters 218a-218M, prior to being supplied to the respective radiating elements 200a-200M.

The components of the return link are, in general, the reverse of those in the forward link. A plurality P of receiving elements 118a-118P receive incoming radio signals in the 2 GHz band from user terminals 2 on the Earth. The signal from each element is filtered and amplified by respective filters 118a-118P and low noise amplifiers 117a-117P, down-converted to a 5 MHz IF signal by an array of down converters, and digitised by a respective ADC 115a-115N and fed to the input ports of a digital beamformer 120.

The uplink beamformer 120 is arranged to apply the same direction control data as the downlink beamformer 220, and amplitude and frequency offset control data supplied from the digital control circuit 13 (in the latter case, the Doppler offset is the same, but the frequency channel is different).

The signals at each of the N output ports of the beamformer 120 comprise 25 KHz bandwidth channels each carrying 40 mS TDMA frames divided into 6 timeslots. They are time-demultiplexed and routed, under control of the control circuit 13, through a router switch 112 to a predetermined input (corresponding to a particular frequency) of a time and frequency multiplexer 111 generating 25 MHz output signals which are converted to analogue signals by a DAC 110. The analogue signals are up-converted into 7 GHz signals by an up converter and RF divider network 108.

As in the to-mobile direction, a time demultiplexer is provided on each channel prior to the router switch 112, so that each timeslot can separately be routed to a different part of the feeder downlink spectrum.

Each RF signal is amplified by an RF power amplifier (e.g. a travelling wave tube or solid state amplifier device) 107a-107d, filtered by a bandpass filter 116a-116d; and supplied to a feeder link antenna 3 for transmission to a respective Earth station.

Thus, the system shown will be seen to consist of a feeder link communication subsystem comprising the elements 3, 106-109 and 206-209; a channel separation and combination subsystem comprising the elements 211-212 and 111-112; and a mobile link communication subsystem comprising the elements 215-218, 115-118, and antennas l and 200.

The digital control circuit 13 comprises a store 502 and a digital processor 504. The store 502 is shown in FIG. 9, and comprises static store 502a and a dynamically updated store 502b, each of which has an entry for each beam. Each beam is associated with a user terminal 2, with which each entry is therefore also associated. Each entry in the static table 502a comprises fields storing: the beam number; data defining the position of the beam aim point on Earth; the channels used (defined as frequency subcarriers of the forward and reverse link channels for the user the timeslots of the forward and reverse link channels; and the power for the forward and reverse link channels for the user).

Each entry in the dynamic table 502b comprises the beam number; data defining the beam direction (relative to the antenna) and the Doppler shift to apply.

The digital processor 504 connected is to the store 502, and receives control data from the Earth Station 6 in the control channel, in each time frame. The control data specifies the user terminal positions, and time and frequencies to be used for each, to be written to the store 502.

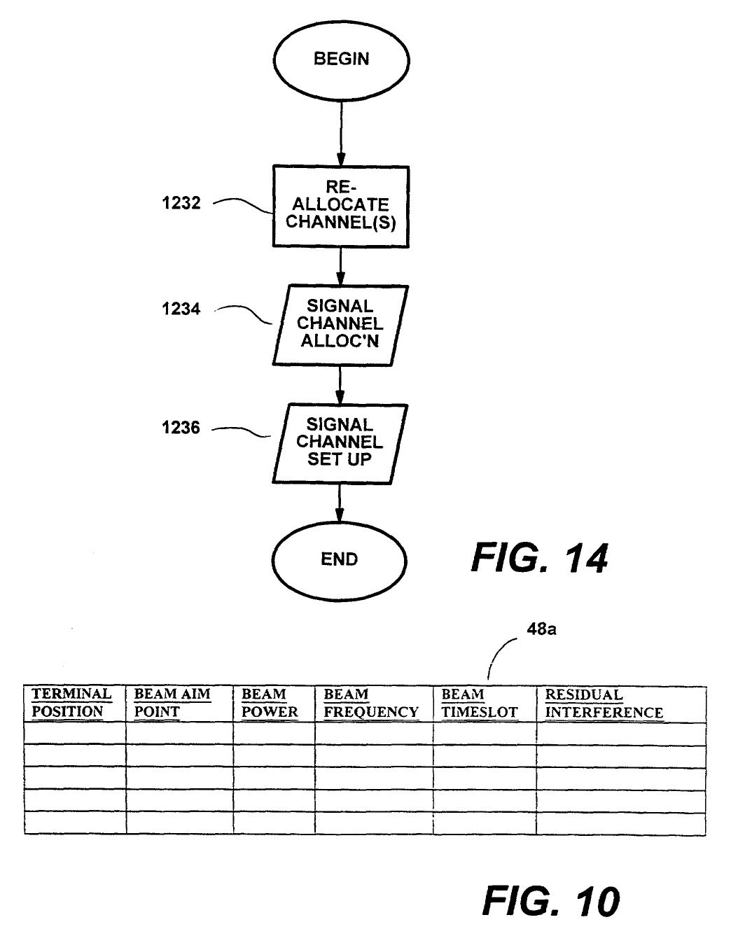

Referring to FIG. 10, the database 48 of the Earth station node 6 in this embodiment, comprises, for each terminal 2, a field defining the terminal position on Earth (e.g. in latitude and longitude, or as a three dimensional position relative to the centre of the Earth), a beam aim point position (which will be discussed in greater detail below) in similar dimensional co-ordinates; a beam power level specifying the power transmitted towards the user terminal; a beam frequency field specifying the frequency of the beam transmitted to the terminal (for example by specifying the frequency channel used); and a time slot field specifying the time slot used for communication by the terminal.

Operation of Satellite 4

The satellite 4 payload performs, essentially, two processing loops; a first in which new beam control data is received from the Earth station 6, and a second in which beam directions and Doppler compensations are periodically re-estimated to maintain direction and frequency accuracy.

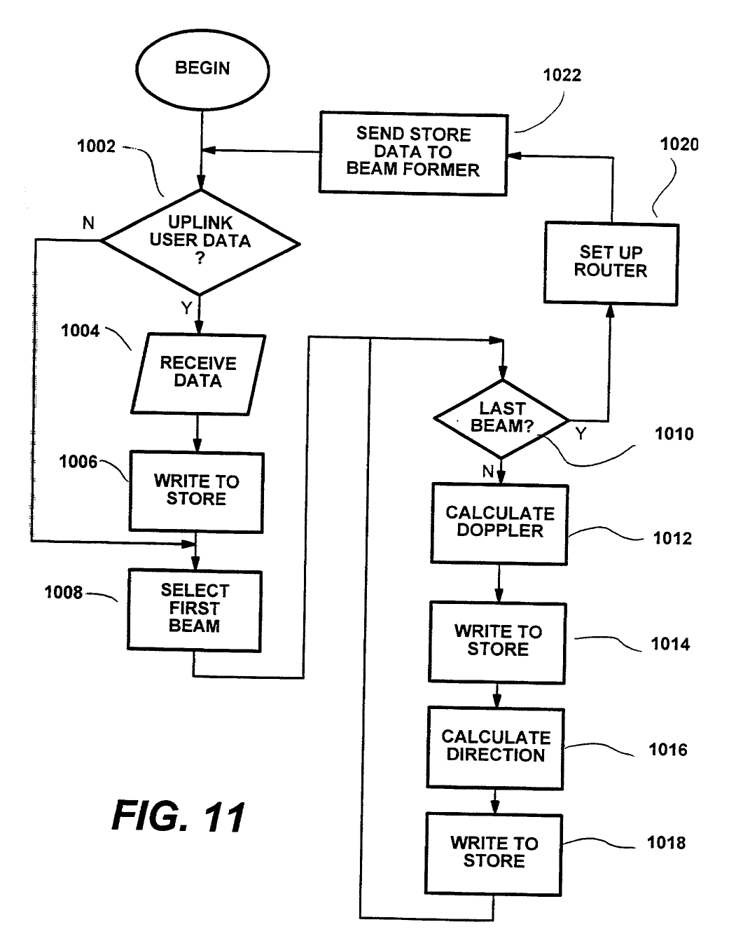

Accordingly, as shown in FIG. 11, in each uplink frame in a step 1002 the satellite 4 determines whether new user beam data is being received from the Earth station 6 (on the control channel C) and, if so, in step 1004, data is received, and written to the store 502 in step 1006.

In step 1008, a first beam is selected from those listed in the store and in step 1010 it is determined whether the current beam is the last beam. If not, in step 1012, the processor 504 calculates the Doppler shift to the user terminal from the satellite, utilising the user terminal position data stored in the table 502a, and the current satellite position (calculated from the satellite orbital data, or from other sources such as a GPS receiver on the satellite) and the satellite orbital speed (which is calculated from its orbit and position).

The Doppler shift information is then stored in the store 502b.

Next, in step 1016, the direction in which the beam is to be pointed (from the satellite) is calculated by reading the beam aim point position data from the table 502a and using the satellite position data as calculated above. This too is written to the store 502b in step 1018.

On having processed the last beam (step 1010) in the table 502, the control circuit 504 amends the router 212, 112 to take account of any new beam assignments from the Earth station 4, and sends the Doppler offset. direction, and power control data to the beamforming network 220, 120. The process then returns to step 1002 to detect further uplinked beam data from the Earth station 6.

The beamformers 220, 120 are operative thereafter to synthesise transmission and reception beams with the designated power, direction and frequency, towards the user terminal, allowing data transmission to take the place in conventional fashion.

The process of FIG. 8 needs to be repeated on each occasion when data is received from the Earth station 6, since the beam aim points on the ground may have changed, or frequency or timeslot allocations may alter as more or less bandwidth is required.

Doppler shift and aim point recalculation needs to be repeated sufficiently frequently to track the movement of the satellite in orbit; in other words, sufficiently frequently that the movement of the satellite footprint on the ground (determined by satellite altitude) in-between successive executions of the process of FIG. 8 is small compared to the width of the beams, so that the gain of the link to the user is essentially unchanged between repetitions.

The processes of determining the beam aim points on the ground an the frequencies to be used for particular users are described fully in our copending UK Patent Application No. . . . filed on the same day as the present application and carrying agents reference (J41746 GB). Accordingly, for clarity, those processes will be omitted from the description of the present invention; they will be understood to be incorporated by reference herein in their entirety.

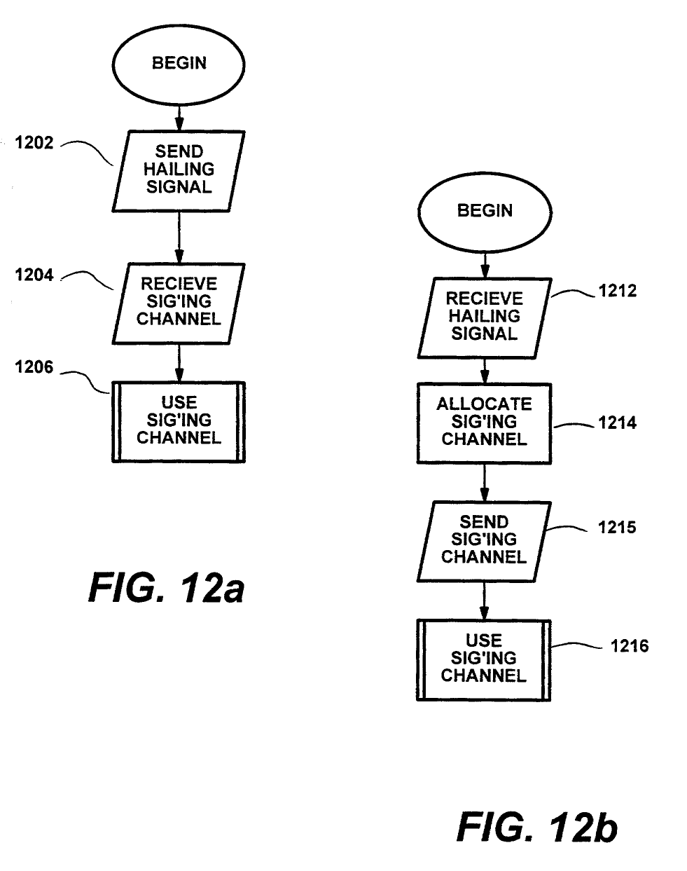

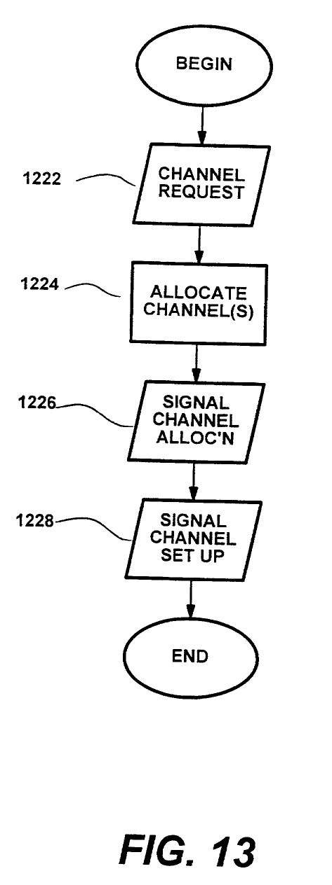

Referring to FIG. 12 on the processes of channel allocation will now be described. Where a mobile terminal 2 is to open a communications session then, in step 1202, it generates a hailing signal on a random access signalling frequency slot within the from-mobile signalling frequency S, which passes through the satellite 4 and is relayed to the Earth station 6 where it is received in the feeder downlink in step 1212. The Earth station 6 allocates a TDMA logical signalling channel for use setting up in the traffic channels to be used by the mobile terminal subsequently.

In step 1215, the Earth station 6 sends a signal on the paging slot of the forward link signalling frequency S channel indicating, to the mobile terminal 2, the TDMA logical signalling channel it should use in future communications. The signalling channel allocated with typically represent one of a number of timeslots on the signalling frequency.

In step 1215, the logical channel identification is transmitted, via the satellite, to the mobile terminal 2 where it is received in step 1204. Subsequently (shown as stages 1206 and 1216), the mobile terminal and Earth station 6 transmit signalling data over allocated signalling channel (strictly, a forward link signalling channel and a return link signalling channel, for communications to and from the mobile terminal respectfully). In particular, channel allocation data is transmitted to the mobile terminal on its allocated signalling channel, as will be described in greater detail below.

Where a voice or data communications session is to take place (either as a result of an incoming call or and outgoing call from the mobile terminal) then in step 122, the mobile terminal 2 requests allocation of one or more channels (e.g. one channel for a normal speech call:two channels for a full rate speech call; multiple to-mobile channels for a database access session: or multiple from-mobile channels for a data upload session).

In step 1224, the requested frequency and timeslots are allocated as disclosed in out above referenced co-pending application filed on the same day as this application. In step 1224, the newly-allocated channels are signalled, on the signalling channel, to the mobile terminal 2, to be used by the mobile terminal 2 in the next time frame.

Having allocated user link time and frequency channels and signalled this allocation to the user terminal 2, the Earth station 6 then allocates feeder link time and frequency channels, by examining those frequency channels already in use for vacant timeslots, and allocating such vacant timeslots. Only where insufficient timeslots are available on the frequency channels currently in use on the feeder link are new frequency channels used in the feeder link; such channels are selected conveniently to be adjacent existing channels, so as to control the total bandwidth from uppermost frequency edge to lower most frequency edge of the feeder link.

Likewise, when channels are de-allocated, the outermost frequency channels in the feeder link are examined and re-allocated to the now vacant timeslots further within the feeder link spectrum. Thus, the bandwidth required by the feeder link spectrum is no greater than required at any time.

Having thus determined the frequency and timeslot on the user link beams and the frequency and timeslots within the feeder link beams to be used in the communication session, the routings to be performed by the routers 112, 212, in the satellite 4 in routing between the feeder link and service link spectra are derived.

In step 1228, the channels are transmitted up to the satellite 4 on the control frequency, for use by the controller 13 on the next time frame.

As described above, the satellite is arranged to read the channel allocations and to set up the routers 212, 112 during the frame header period before the next traffic channel, so that the change over from one channel to another can take place simultaneously and immediately (next frame), at the satellite and the mobile terminal and the Earth station.

The volume of re-allocation data carried on the control channel will normally be relatively modest. This is because, relative to the volume of other traffic, the number of new calls being set up or pulled down is small. Changes in the channel allocation may also be performed by the Earth station 6 where a handover is to be performed, for example, due to motion of the satellite or the appearance of an interferer or blockage.

Referring to FIG. 14, during an existing call the channel allocation may also be varied; for example, because the call had closed (in which case the channel is cleared down).

Equally, for “bursty” data communications, where the data rate may change within a call session, the terminal equipment 160, mobile terminal 2, or Earth station 6 may accordingly vary the number of channels to be allocated to the user terminal mid-session.

Where a mobile terminal 2 is arranged to handle variable bandwidth communications, this may conveniently be by varying the number of timeslots used by the mobile terminal.

As it is anticipated that the bandwidth in the to-mobile direction will usually be large (to enable the mobile terminal to receive high bandwidth data such as Internet or multimedia files, or television), more timeslots are provided in the to-mobile direction to enable, in this case, 36 different multiples of the basic 4 KHz bandwidth to be employed by the mobile terminal.

Alternatively, the mobile terminal 2 could be provided with a variable acceptance width filter, to receive several adjacent frequency channels, or with multiple RF receivers to receive several non-adjacent frequency channels simultaneously.

Referring to FIG. 14, accordingly in step 1232, the Earth station reallocates channels in the same manner as the initial channel allocation, to avoid or reduce interference with other terminals: in step 1234 signals the new channel allocation on the signalling channel on the mobile terminal 2; and in step 1236 signals the new allocation on the control channel to the satellite 4.

Second Embodiment

In this embodiments, the invention is arranged to be capable of altering the TDMA frame time; for example between 40 mS and 240 mS. Accordingly, the time demultiplexers 211b, 21b . . . are configurable to vary the number of output ports they use, and the control channel is arranged to carry TDMA length control data causing the digital control processor 30 to control the number of time channels between which the time demultiplexers distribute TDMA bursts.

Separate control information on the TDMA frame length (i.e. number of bursts per frame) is transmitted on the control channel for each of the frequency channels, enabling each time demultiplexer to be controlled separately.

The multiplexers and demultiplexers at the Earth station 6 and user terminal 2 (not shown) are correspondingly of controllably variable frame length, and the Earth station 6 transmits reconfiguration information on the signal channel to cause each mobile terminal 2 to vary its frame length accordingly.

Thus, in this embodiment, the data rate may be varied even more substantially than in the first, since not only may the number of timeslots within a frame used by a given user terminal may be varied by also the number of timeslots available for use in the frame may also be varied.

Summary of Embodiments

The channel allocation signalling and set up methods described herein will be seen to have various advantages when compared with those proposed in the past.

Firstly, the separate demultiplexing of each timeslot within the satellite allows more efficient use of the feeder band spectrum. This is because feeder band frequency channels may be closely packed with timeslots, even though, to reduce co-channel interference, such timeslots could not all co-exist in the user link beams.

In a conventional satellite communications system, the required feeder link spectrum corresponds to the number of frequency channels actually in use in the user link spectrum (counting each re-use of a frequency channel separately) so that, for example, where 22000 frequency channels are in use then the feeder link spectrum would require a bandwidth of 2,000 times the bandwidth of a single frequency channel.

By contrast, according to the present invention if, say, only a single timeslot is being used on each frequency channel in the user link then the feeder link spectrum required can be divided by the number of timeslots present, requiring in the above embodiment merely 1/36 of the total bandwidth which would be required in the prior art.

By providing that the satellite 4 is capable of routing any communications channel (i.e. frequency link/timeslot combination) through a different frequency and/or timeslot in each frame, by signalling in one frame to cause a changeover in the allocation in the following frame, the invention is capable of handling bursty communications, and of performing rapid handover.

It is also able to make highly efficient use of the satellite resources for the transmission of packet switched data, by using spare traffic channel capacity on a burst-by-burst basis, and thus accommodating the transmission of packet switched messages of widely variable length and different bandwidths.

Providing the Doppler correction at the satellite enables the channel spacing on the feeder link to the Earth station node 6 to be reduced, since it is not necessary to provide for the possibility of Doppler correction within the feeder link; accordingly, the channels are closely multiplexed together in the feeder link on adjacent frequency bands without substantial frequency guard bands.

Since the satellite is calculating the Doppler compensation to be applied for each channel, it is also convenient for the satellite to calculate the beam directions as the satellite moves in orbit. Thus, it is only necessary for the Earth station node 6 to transmit beam aim points on Earth, on a relatively infrequent basis, rather than continually uplinking beam steering commands. This reduces the volume of signalling on the uplink control channels from the Earth station node 6.

In other respects, however, the satellite is able to act as a transparent transponder, repeating the signal from the feeder link on to the user terminal beams and vice versa without needing to demodulate the signals (which would require substantial on-board processing and could introduce additional signal delays).

Other Embodiments

It will be clear from the foregoing that the above described embodiment is merely one way of putting the invention into effect. Many other alternatives will be apparent to the skilled person and are within the scope of the present invention.

It would be possible to use the allocation methods described in the first and second embodiments where a fixed grid of beams were provided, as an alternative to a rigid frequency re-use pattern.

Whilst single beams allocated to each user have been described, it would be possible (for example, where a large number of users are known to be at almost exactly the same position on Earth) to provide a single beam serving multiple users on a single or common frequency allocating different time slots to each.

The numbers of satellites and satellite orbits indicated are purely exemplary. Smaller numbers of geostationary satellites, or satellites in higher altitude orbits, could be used; or larger numbers of low Earth orbit (LEO) satellites could be used. Equally, different numbers of satellites in intermediate orbits could be used.

Although TDMA has been mentioned as suitable access protocol, the present invention may be applicable to other access protocols, such as code division multiple access (CDMA) in which a limited number of codes, or nonorthogonal codes are re-used or pure frequency division multiple access (FDMA).

Equally, whilst the principles of the present invention are envisaged above as being applied to satellite communication systems, the possibility of the extension of the invention to other communications systems (e.g. digital terrestrial cellular systems such as GSM) is not excluded.

It will be understood that components of embodiments of the invention may be located in different jurisdictions or in space. For the avoidance of doubt, the scope of the protection of the following claims extends to any part of a telecommunications apparatus or system or any method performed by such a part, which contributes to the performance of the inventive concept.

1. A satellite system comprising at least one satellite (4); at least one Earth station (6), and a plurality of user terminals (2),
the satellite (4) being arranged to provide a link between each user terminal (2) and the Earth station (6), via communications channels,
each channel comprising one or more timeslots in a repeating time frame on one or more frequencies, carried by a feeder link beam between said satellite (4) and the or each said Earth station (6), and one of a plurality of user terminal link beams (B1-BN) between the satellite (4) and the user terminals (2),
the satellite comprising a multiplexer (211) for multiplexing the channels from multiple said terminal link beams onto each said feeder link beam, and a demultiplexer (111) for demultiplexing the channels from onto each said feeder link beam onto multiple said terminal link beams;
and further comprising at least one router (112, 212) for assigning channels to and from particular said terminal link beams in response to control signals from said Earth station (6),
characterized in that the Earth station (6) is arranged to send, during a first said frame period, channel assignment signals relating to channel assignments in a following said frame period,
and in that the satellite (4) is arranged to control the router (112, 212) in accordance with said channel assignment signals in said following frame period.

2. A system according to claim 1, in which said following frame period is the next following frame period.

3. A system according to claim 2, in which the number of said slots in a said frame in the from-terminal direction is different to that in the to-terminal direction.

4. A system according to claim 3, in which the length of a said frame in the from-terminal direction is the same as that in the to-terminal direction.

5. A system according to claim 3 or claim 4, in which the bandwidth provided by each of said slots in a said frame in the from-terminal direction is the same as that in the to-terminal direction.

6. A system according to any of claims 3 to 5, in which there are more said timeslots in the to-terminal direction than in the from-terminal direction.

7. A system according to any preceding claim, in which the number of slots in a said frame is variable.

8. A system according to any preceding claim, in which the satellite (4) comprises means (211b) for time-demultiplexing said slots of each frame and said router (112, 212) is arranged to route slots of a single frame to different frequencies, or vice-versa, and to vary the routing of slots of a said frame on a said frequency.

9. A system according to claim 8 appended to claim 7, in which the length of the time-demultiplexer means (211b) is variable to accommodate said variable number of slots.

10. A satellite system comprising at least one satellite (4); at least one Earth station (6), and a plurality of user terminals (2),
the satellite (4) being arranged to provide a link between each user terminal (2) and the Earth station (6), via communications channels,
each channel comprising one or more timeslots in a repeating time frame on one or more frequencies, carried by a feeder link beam between said satellite (4) and the or each said Earth station (6), and one of a plurality of user terminal link beams (B1-BN) between the satellite (4) and the user terminals (2),
the satellite comprising a multiplexer (211) for multiplexing the channels from multiple said terminal link beams onto each said feeder link beam, and a demultiplexer (111) for demultiplexing the channels from onto each said feeder link beam onto multiple said terminal link beams;
and further comprising at least one router (112, 212) for assigning channels to and from particular said terminal link beams in response to control signals from said Earth station (6),
characterized in that there are more said timeslots in the to-terminal direction than in the from-terminal direction.

11. A satellite system comprising at least one satellite (4); at least one Earth station (6), and a plurality of user terminals (2),
the satellite (4) being arranged to provide a link between each user terminal (2) and the Earth station (6), via communications channels,
each channel comprising one or more timeslots in a repeating time frame on one or more frequencies, carried by a feeder link beam between said satellite (4) and the or each said Earth station (6), and one of a plurality of user terminal link beams (B1-BN) between the satellite (4) and the user terminals (2),
the satellite comprising a multiplexer (211) for multiplexing the channels from multiple said terminal link beams onto each said feeder link beam, and a demultiplexer (111) for demultiplexing the channels from onto each said feeder link beam onto multiple said terminal link beams;
and further comprising at least one router (112, 212) for assigning channels to and from particular said terminal link beams in response to control signals from said Earth station (6),
characterized in that the number of slots in a said frame can be varied.

12. A system according to claim 11, in which said number can be varied independently for each said frequency channel.

13. A system according to any preceding claim, in which a single said beam is provided for each said user terminal (2).

14. A system according to any preceding claim, comprising a plurality of said satellites covering a region of the Earth.

15. A system according to claim 14, in which said satellites form a non-geostationary constellation.

16. A system according to claim 15, in which said constellation provides global coverage.

17. A system according to any of claims 14 to 16, in which the or each satellite (4) comprises means for applying a Doppler shift correction to each said beam.

18. A system according to any preceding claim, in which said user terminals (2) comprise handheld terminals.

19. Channel allocation apparatus for use in the system of any preceding claim.

20. Apparatus according to claim 19, said apparatus being provided at a said Earth station (6).

21. A satellite for use in the system of any of claims 1 to 20.

22. A user terminal for use in the system of any of claims 1 to 20.

23. A method of TDMA satellite communications with a user terminal, in which the satellite separately routes individual TDMA bursts of a given frequency channel and varies said routing from frame to frame.

24. A method of TDMA satellite communications with a user terminal, in which the number of said slots in a said frame in the from-terminal direction is different to that in the to-terminal direction.

25. A method according to claim 24, in which the bandwidth of said slots is the same in the from-terminal direction to that in the to-terminal direction.

26. A method according to claim 24, comprising varying the number of said slots allocated to a user terminal.

27. A method according to claim 24, comprising varying the number of said slots in a said TDMA frame.

28. A method according to claim 27, comprising varying the number of said slots in a said TDMA frame on a first frequency differently to that on a second frequency.
